(19) United States
(12) Patent Application Publication
(10) Pub. No.: US 2024/0187880 A1
(43) Pub. Date: Jun. 6, 2024

(54) SYSTEMS AND METHODS FOR CONFIGURATION INFORMATION TRANSFER

(71) Applicant: ZTE Corporation, Shenzhen (CN)

(72) Inventors: Ying HUANG, Shenzhen (CN); Lin CHEN, Shenzhen (CN)

(73) Assignee: ZTE Corporation, Shenzhen (CN)

(21) Appl. No.: 18/429,902

(22) Filed: Feb. 1, 2024

Related U.S. Application Data
(63) Continuation of application No. PCT/CN2021/110697, filed on Aug. 5, 2021.

(51) Int. Cl. H04W 24/02; H04W 16/26; H04W 88/08

(52) U.S. Cl. CPC H04W 24/02; H04W 16/26; H04W 88/085

(57) ABSTRACT

Presented are systems and methods for transferring configuration information. A first integrated access and backhaul (IAB) donor may send an Xn application protocol (XnAP) message to a second IAB donor. The XnAP message may be to transfer an updated information of an IAB distributed unit (IAB-DU) to the second IAB donor.

### CROSS-REFERENCE TO RELATED APPLICATION

This application claims the benefit of priority under 35 U.S.C. § 120 as a continuation of International Patent Application No. PCT/CN2021/110697, filed on Aug. 5, 2021, the disclosure of which is incorporated herein by reference in its entirety.

### TECHNICAL FIELD

The disclosure relates generally to wireless communications, including but not limited to systems and methods for transferring configuration information.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A first integrated access and backhaul (IAB) donor may send an Xn application protocol (XnAP) message to a second IAB donor. The XnAP message may be to transfer an updated information of an IAB node to the second IAB donor. The XnAP message can comprise a UE-associated XnAP message.

In some embodiments, the first IAB donor receives, prior to sending the XnAP message, a message from an IAB entity. The first IAB donor can include a F1-terminating donor, or a source IAB donor, or an initial IAB donor. The IAB entity can include an IAB node (e.g., a migrating IAB node or a recovery IAB node) or the second IAB donor (e.g., a non F1-terminating donor or a target IAB donor or a new IAB donor). The message can include an indication to the first IAB donor to maintain or keep at least one of: a user equipment (UE) context, a mobile termination (MT) context or a UE-associated Xn connection between the first IAB donor and the second IAB donor.

In some embodiments, the first IAB donor sends a request to the second IAB donor, to indicate that at least one of: a user equipment (UE) context, a mobile termination (MT) context or an UE-associated Xn connection between the first IAB donor and the second IAB donor, is to be maintained or kept.

In some embodiments, the first IAB donor comprises a F1-terminating donor, or a source IAB donor, or an initial IAB donor. The IAB entity can comprise an IAB node or a second IAB donor. The message (e.g., F1AP or Xn AP message) can include an identifier of the IAB node, the identifier including at least one of: a distributed unit (DU) identifier (ID), a backhaul adaptation protocol (BAP) address of the IAB node that is allocated by the non F1-terminating donor, an internet protocol (IP) address of the IAB node that is allocated by the non F1-terminating donor, or a UE F1 application protocol (F1AP) ID of an IAB mobile termination (IAB-MT).

In certain embodiments, the first IAB donor sends to the second IAB donor a non-UE-associated XnAP message to transfer an updated information of an IAB node to the second IAB donor, the non-UE-associated XnAP message including an identifier of the IAB node. The updated information may include at least one of: an IAB node configuration information, or quality of service (QoS) information. The IAB node configuration information can include at least one of: multiplexing capability information, an activated cell list, a DUF configuration, a hard/soft/not-available (HSNA) configuration, a cell specific signal or channel configuration. The QoS information can include at least one of: a backhaul (BH) radio link control (RLC) channel (CH) identifier (ID), a BH RLC CH QoS, an evolved-UMTS terrestrial radio access network (E-UTRAN) BH RLC CH QoS, a control plane traffic type, a data radio bearer (DRB) ID, a QoS of a DRB, a F1 user plane interface (F1-U) GPRS tunneling protocol (GTP) tunnel ID, or a QoS of a F1-U tunnel.

In some embodiments, a second integrated access and backhaul (IAB) donor receives from a first IAB donor an Xn application protocol (XnAP) message. The XnAP message may be to transfer an updated information of an IAB node to the second IAB donor.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3A illustrates an example inter-donor migration or RLF recovery scenario, according to some embodiments of the present disclosure;

FIG. 3B illustrates an example inter-donor topology redundancy scenario, in accordance with some embodiments of the present disclosure; and

FIG. 4 illustrates a flow diagram of an example method for transferring updated information, in accordance with an embodiment of the present disclosure.

### DETAILED DESCRIPTION

### 1. Mobile Communication Technology and Environment

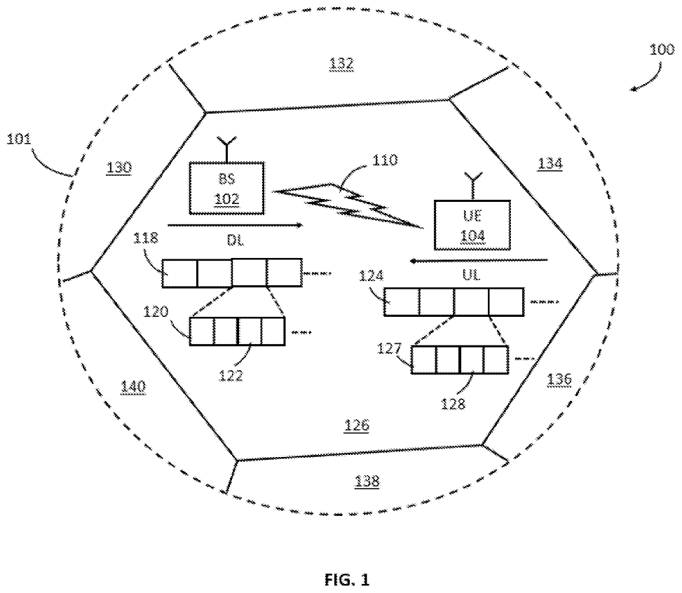

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

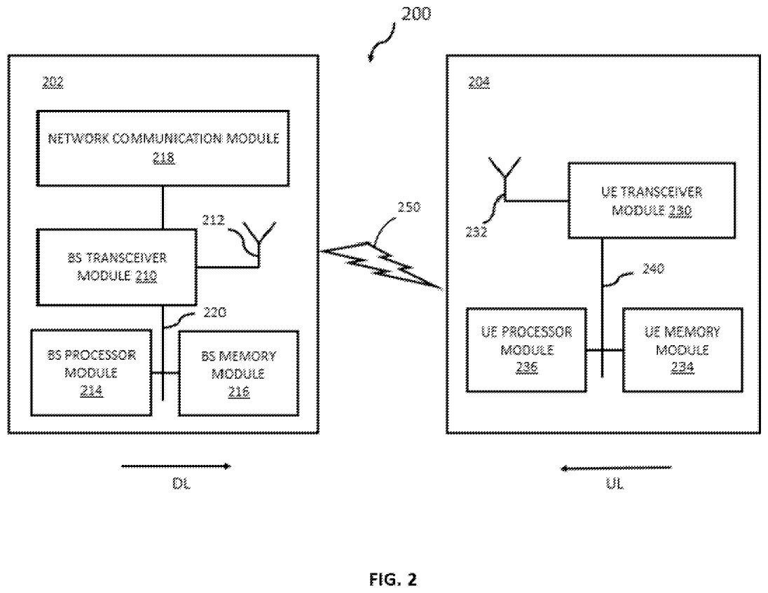

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Configuration Information Transfer

In certain systems (e.g., 5G new radio (NR), Next Generation (NG) systems, 3GPP systems, and/or other systems), an Integrated Access and Backhaul (IAB) supports wireless backhauling via NR for example, enabling flexible and very dense deployment of NR cells while reducing the need for wireline transport infrastructure.

IAB can enable wireless relaying in NG-RAN for instance. The relaying node, referred to as an IAB-node, can support access and backhauling via NR. The terminating node of NR backhauling on network side may be referred to as the IAB-donor, which can represent a gNB with additional functionality to support IAB. Backhauling can occur via a single or via multiple hops.

The IAB-node can support gNB distributed unit (DU) functionality, to terminate the NR access interface to UEs and next-hop IAB-nodes, and to terminate the F1 protocol to the gNB centralized unit (CU) functionality, on the IAB-donor. The gNB-DU functionality on the IAB-node is also referred to as IAB-DU.

In addition to the gNB-DU functionality, the IAB-node can also support a subset of the UE functionality referred to as IAB mobile termination (MT), which includes, e.g., physical layer, layer-2, radio resource control (RRC) and non-access stratum (NAS) functionality to connect to the gNB-DU of another IAB-node or the IAB-donor, to connect to the gNB-CU on the IAB-donor, and to the core network. The IAB-node can access the network using either standalone (SA) mode or E-UTRA NR dual connectivity (EN-DC). In EN-DC, the IAB-node can connect via an E-UTRA to a MeNB, and the IAB-donor can terminate a X2 control plane (X2-C) as a SgNB.

All IAB-nodes that are connected to an IAB-donor via one or multiple hops can form a directed acyclic graph (DAG) topology with the IAB-donor as its root. In this DAG topology, the neighbor node of the IAB-DU or the IAB-donor-DU is referred to as child node and the neighbor node of the IAB-MT is referred to as parent node. The direction toward the child node is referred to as downstream while the direction toward the parent node is referred to as upstream. The IAB-donor can perform centralized resource, topology and route management for the IAB topology.

In some embodiments, inter-donor resource multiplexing is implemented, for which a number of scenarios can apply. The present disclosure, in some aspects, addresses approaches (e.g., systems, devices, methods) to achieve resource multiplexing across multiple IAB donors in an IAB network. In various embodiments, one or more of the following definitions/descriptions can also apply:

IAB-donor: a gNB that provides network access to UEs via a network of backhaul and access links.

IAB-donor-CU: a gNB-CU of an IAB-donor, terminating a F1 interface towards IAB-nodes and an IAB-donor-DU.

IAB-donor-DU: a gNB-DU of an IAB-donor, hosting a IAB backhaul adaptation protocol (BAP) sublayer, and/or providing wireless backhaul to IAB-nodes.

IAB-DU: gNB-DU functionality supported by an IAB-node to terminate the NR access interface to UEs and next-hop IAB-nodes, and/or to terminate the F1 protocol to the gNB-CU functionality, on an IAB-donor.

IAB-MT: an IAB-node function that terminates the Uu interface to a parent node using procedures and behaviors specified for UEs unless stated otherwise. Certain IAB-MT functions can include or correspond to certain IAB-UE functions.

IAB-node: a RAN node that supports NR access links to UEs and NR backhaul links to parent nodes and child nodes. The IAB-node does not support backhauling via long term evolution (LTE) system.

Child node: an IAB-DU's and IAB-donor-DU's next hop neighbor node; the child node is also an IAB-node.

Parent node: an IAB-MT's next hop neighbor node; the parent node can be an IAB-node or IAB-donor-DU

Upstream: Direction towards parent node in IAB-topology.

Downstream: Direction towards child node or UE in IAB-topology.

### First Scenario: Inter-Donor Migration or Radio Link Failure (RLF) Recovery for Single Connected IAB-Node

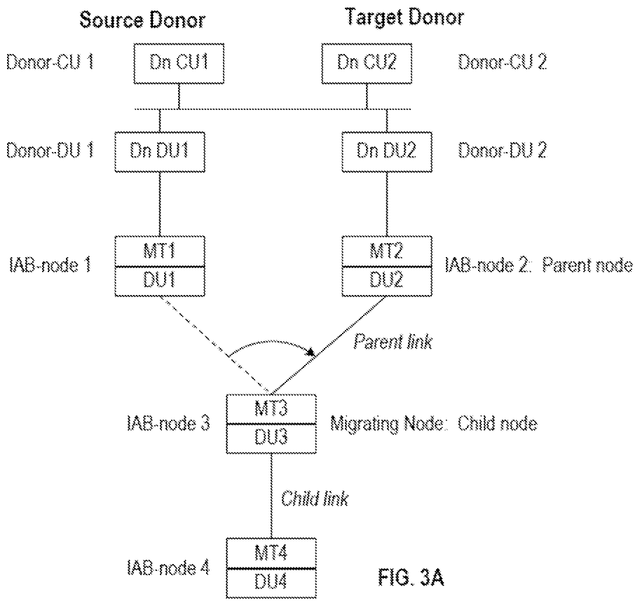

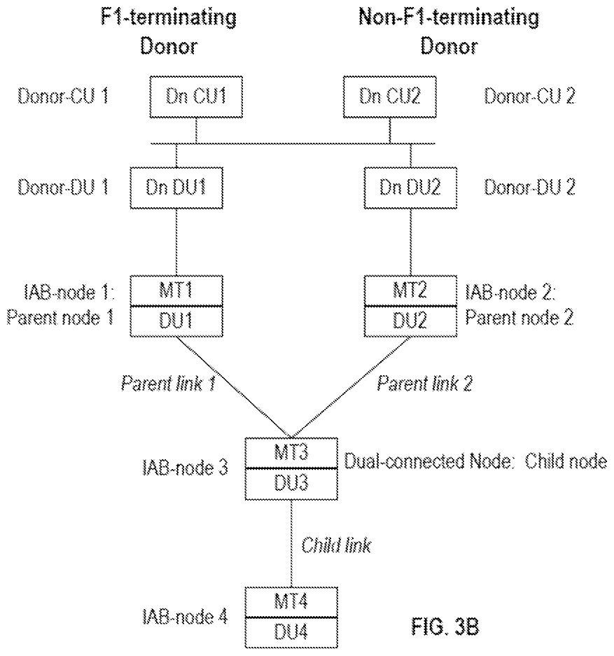

Referring now to FIG. 3A, depicted is an inter-donor migration or RLF recovery scenario, according to some embodiments of the present disclosure. In the inter-donor migration scenario, a boundary node (IAB node 3) can connect to a source parent IAB node (IAB node 1) which is controlled by a source donor before IAB-MT migration. And after IAB-MT migration, the boundary node can connect to a target parent IAB node (IAB node 2) which is controlled by a target donor. The boundary node can have a F1 connection with the source donor before and after the IAB-MT migration.

In the inter-donor RLF recovery scenario, the boundary node (IAB node 3) can connect to an initial parent IAB node (IAB node 1) which is controlled by an initial donor CU (donor CU1) before recovery. And after recovery, the boundary node can connect to the new parent IAB node (IAB node 2) which is controlled by a new IAB donor (donor CU2). The boundary node can have a F1 connection with the initial IAB donor before and after the IAB-MT RLF recovery.

In this disclosure, a source/initial IAB donor is sometimes referred to as a F1-terminating donor, while a target/new IAB donor is sometimes referred to as a non F1-terminating donor.

### Second Scenario: Inter-Donor Topology Redundancy for Dual-Connected IAB-Node

Referring now to FIG. 3B, depicted is an inter-donor topology redundancy scenario, according to some embodiments of the present disclosure. A boundary node (IAB node 3) can connect/link to two parent nodes simultaneously. A parent node 1 (IAB node 1) may be controlled by a donor CU1 while a parent node 2 (IAB node 2) can be controlled by a donor CU2. However, the boundary node may only have a F1 connection with IAB donor CU1. So, donor CU1 may be referred to as a F1-terminating donor, and IAB donor CU2 may be referred to as a non-F1 terminating donor, in some embodiments.

For a boundary node, time domain multiplexing may be used between a parent link and a child link of an IAB node, for instance to meet the half-duplexing constraint/implementation of the IAB node. Both of the two IAB donors and the two parent nodes are to be aware of the boundary IAB-DU's (e.g., IAB node's) configuration (e.g., multiplexing capability information, an activated cell list, a DUF (Downlink/uplink/flexible) configuration, a HSNA (Hard/soft/not available) configuration, a cell specific signal or channel configuration), so that the IAB donors and the parent nodes could configure/schedule the boundary IAB node accordingly, in some embodiments. As such, the boundary IAB node's configurations are to be transferred from the one IAB donor to another IAB donor, in some implementations. In addition, quality of service (QoS) information may (need to) be transferred from the F1-terminating IAB donor to the non F1-terminating IAB donor, so that the non F1-terminating IAB donor can (re)configure a backhaul (BH) radio link radio link control (RLC) channel at a target path accordingly.

However, the boundary IAB-DU's (e.g., IAB node's) configuration may change, e.g., after the F1 terminating donor updates boundary IAB-DU's activated cell list. Whenever the boundary IAB-DU (or IAB node)'s information (e.g., configuration) changes or is updated, the updated information (e.g., updated IAB-DU configuration) is to be transferred from the F1-terminating donor to the non F1-terminating donor, for example. In an inter-donor topology redundancy scenario, a XnAP S-NODE modification request message could be used/enhanced/adapted to transfer the updated information (e.g., updated IAB-DU configuration). However, for inter-donor migration/RLF recovery scenarios, the resources at the F1-terminating donor related to the UE-associated signaling connection between the F1-terminating donor CU and the non F1-terminating donor CU is to be released after receiving a XnAP UE CONTEXT RELEASE message. So a problem to be solved/addressed is how to transfer the updated information (e.g., updated IAB-DU configuration) from the F1-terminating donor to the non F1-terminating donor in inter-donor migration/RLF recovery scenarios.

### Example Implementation/Solution 1: Using a UE Associated XnAP Message

In some embodiments, a target/new IAB donor (e.g., a non F1-terminating donor CU) sends an indication to a source/initial IAB donor (e.g., a F1-terminating donor) to indicate that a UE/MT context is to be kept, or a UE associated Xn connection between the two IAB donors is to be kept. The indication may be included in a first message such as an XnAP message (e.g., a XnAP UE CONTEXT RELEASE message, handover request acknowledge message, retrieve UE context request message). Optionally, in some implementations, source/initial IAB donor (e.g., the F1-terminating donor) sends a request information to the target/new IAB donor (e.g., non F1-terminating donor CU) to request that the UE (or MT) context be kept or that the UE associated Xn connection between the two IAB donors be kept.

If the source/initial IAB donor (e.g., F1-terminating donor) receives the indication, the UE context of a corresponding IAB node (e.g., of a boundary IAB-MT) and/or resources related to the UE-associated signaling connection between the two IAB donors (e.g., donor CUs) are kept/maintained at the source/initial IAB donor (e.g., F1-terminating donor) after receiving a XnAP UE CONTEXT RELEASE message for instance.

The source/initial IAB donor (e.g., F1-terminating donor) can send an UE associated XnAP message to transfer updated information (e.g., updated IAB node or IAB-DU configuration information) of the boundary IAB node (e.g., IAB-DU) from the source/initial IAB donor (e.g., F1-terminating donor) to the target/new IAB donor (e.g., non F1-terminating donor). More specifically, and in some embodiments, the updated information includes at least one of the following: IAB node (or IAB-DU) configuration, QoS information. QoS information can include at least one of the following: a BH RLC channel (CH) ID, a BH RLC CH QoS, an evolved-UMTS terrestrial radio access network (E-UTRAN) BH RLC CH QoS, a control plane traffic type, a data radio bearer (DRB) ID, QoS of the DRB, a F1 user plane interface (F1-U) GPRS tunneling protocol (GTP) tunnel ID, QoS of the F1-U tunnel. IAB node (or IAB-DU) configuration information can include at least one of: multiplexing capability information, an activated cell list, a DUF configuration, a HSNA configuration, or a cell specific signal/channel configuration.

### Example Implementation/Solution 2: Using a Non-UE Associated XnAP Message

In an example implementation, a boundary IAB node (e.g., IAB-DU) can send an identifier of the IAB node (IAB-DU) to a source/initial IAB donor (e.g., F1-terminating donor) via a first message (e.g., a F1AP message). The identifier of the IAB bode (or IAB-DU) can includes at least one of the following: a DU ID, a BAP address of an IAB node which is allocated by the target/new IAB node (or non F1-terminating donor), an IP address of the IAB node which is allocated by the target/new IAB node (or non F1-terminating donor), a UE F1AP ID of IAB-MT (which can be a gNB-CU UE F1AP ID) which can be allocated by the target/new IAB donor (e.g., non F1-terminating donor), or a gNB-DU UE F1AP ID.

The source/initial IAB donor (or F1-terminating donor CU) can send a message (e.g., a non-UE associated XnAP message) to the target/new IAB donor (or non F1-terminating donor) to transfer updated information (e.g., updated IAB node or IAB-DU configuration) of the corresponding boundary IAB node. The identifier of the IAB-DU (or IAB node) can be included in the message (e.g., non-UE associated XnAP message).

More specifically, and in some embodiments, the updated information includes at least one of the following: an IAB node (or IAB-DU) configuration, QoS information. QoS information can include at least one of the following: a BH RLC channel (CH) ID, a BH RLC CH QoS, an evolved-UMTS terrestrial radio access network (E-UTRAN) BH RLC CH QoS, a control plane traffic type, a data radio bearer (DRB) ID, QoS of the DRB, a F1 user plane interface (F1-U) GPRS tunneling protocol (GTP) tunnel ID, QoS of the F1-U tunnel. IAB node (or IAB-DU) configuration information can includes at least one of: multiplexing capability information, an activated cell list, a DUF configuration, a hard/soft/not-available (HSNA) configuration, or a cell specific signal or channel configuration.

### Example Implementation/Solution 3: Using a Non-UE Associated XnAP Message

In an example implementation, a target/source IAB donor (or non F1-terminating donor CU) can send an identifier of a IAB node (or IAB-DU) to a source/initial IAB donor (e.g., the F1-terminating donor) via a first message (e.g., a XnAP message). The identifier of the IAB node or IAB-DU can include at least one of the following: a DU ID, a BAP address of IAB node, which can be allocated by the target/new IAB donor (or non F1-terminating donor), an IP address of the IAB node which may be allocated by the target/new IAB donor (or non F1-terminating donor), or a UE F1AP ID of the IAB node (or IAB-MT) which can be a gNB-CU UE F1AP ID which is allocated by the target/new IAB donor (or non F1-terminating donor), or a gNB-DU UE F1AP ID.

The source/initial IAB donor (or F1-terminating donor CU) can send a message (e.g., a non-UE associated XnAP message) to the target/new IAB donor (or non F1-terminating donor) to transfer updated information (e.g., updated IAB node or IAB-DU configuration) of the boundary IAB node. The identifier of the IAB node (or IAB-DU) can be included in the message (e.g., the non-UE associated XnAP message).

More specifically, and in some embodiments, the updated information includes at least one of the following: an IAB node (or IAB-DU) configuration, QoS information. QoS information can include at least one of the following: a BH RLC channel (CH) ID, BH RLC CH QoS, an evolved-UMTS terrestrial radio access network (E-UTRAN) BH RLC CH QoS, a control plane traffic type, a data radio bearer (DRB) ID, QoS of the DRB, a F1 user plane interface (F1-U) GPRS tunneling protocol (GTP) tunnel ID, QoS of the F1-U tunnel. The IAB node (or IAB-DU) configuration information can include at least one of: multiplexing capability information, an activated cell list, a DUF configuration, a HSNA configuration, or a cell specific signal or channel configuration.

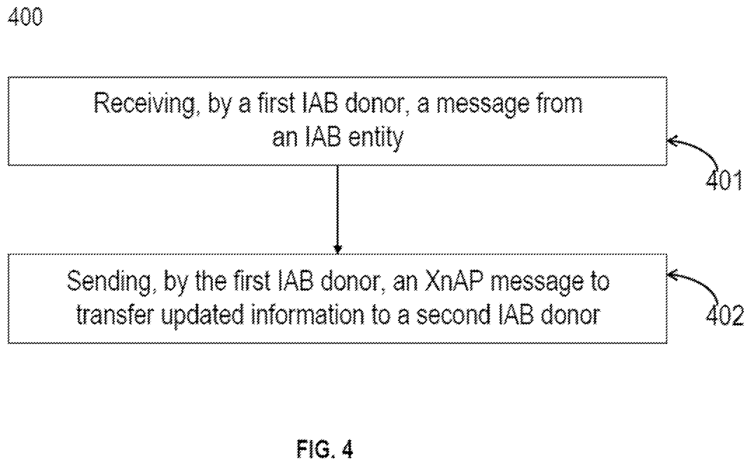

FIG. 4 illustrates a flow diagram of a method 400 for transferring updated information. The method 400 may be implemented using any of the components and devices detailed herein in conjunction with FIGS. 1-3. In overview, the method 400 may include a first IAB donor receiving a message from an IAB entity (401). The method 400 may include the first IAB donor sending an XnAP message to transfer updated information to a second IAB donor (402).

Referring now to operation (401), and in some embodiments, a first IAB donor receives, prior to sending an Xn application protocol (XnAP) message, a first message from an IAB entity. The second IAB donor can receive from the first IAB donor the XnAP message. The XnAP message may be to carry and/or transfer an updated information of the IAB node (or IAB distributed unit (IAB-DU)) to the second IAB donor.

The first IAB donor can include a F1-terminating donor, or a source IAB donor, or an initial IAB donor. The IAB entity can include an IAB node (e.g., a migrating IAB node or a recovery IAB node) or the second IAB donor (e.g., a non F1-terminating donor or a target IAB donor or a new IAB donor). The first message can include an indication to the first IAB donor to maintain or keep at least one of: a user equipment (UE) context, a mobile termination (MT) context or a UE-associated Xn connection between the first IAB donor and the second IAB donor.

Referring now to operation (402), and in some embodiments, the first (e.g., source/initial) IAB donor may send the XnAP message to a second (e.g., target/new) IAB donor. The XnAP message may be used to carry and/or transfer an updated information of the IAB node or IAB distributed unit (IAB-DU), to the second IAB donor. The XnAP message can include the updated information. The XnAP message can comprise a UE-associated XnAP message.

In some embodiments, the first (e.g., source/initial) IAB donor sends a request to the second (e.g., target/new) IAB donor, to indicate that at least one of: a user equipment (UE) context, a mobile termination (MT) context or an UE-associated Xn connection between the first IAB donor and the second IAB donor, is to be maintained or kept (e.g., at/by the second IAB donor).

In some embodiments, the first IAB donor comprises a F1-terminating donor, or a source IAB donor, or an initial IAB donor. The IAB entity can comprise an IAB node or a second IAB donor. The message (e.g., a F1AP or Xn AP message) can include an identifier of the IAB node. The identifier can include at least one of: a distributed unit (DU) identifier (ID), a backhaul adaptation protocol (BAP) address of the IAB node that is allocated by the non F1-terminating donor, an internet protocol (IP) address of the IAB node that is allocated by the non F1-terminating donor, or a UE F1 application protocol (F1AP) ID of an IAB mobile termination (IAB-MT).

In certain embodiments, the first (e.g., source/initial) IAB donor sends to the second (e.g., target/new) IAB donor a message (e.g., a non-UE-associated XnAP message) to transfer an updated information of an IAB node to the second IAB donor. The message (e.g., non-UE-associated XnAP message) can include the identifier of the IAB node. The updated information may include at least one of: an IAB node (or IAB-DU) configuration information, or quality of service (QoS) information. The IAB node (or IAB-DU) configuration information can include at least one of: multiplexing capability information, an activated cell list, a DUF configuration, a hard/soft/not-available (HSNA) configuration, a cell specific signal or channel configuration. The QoS information can include at least one of: a backhaul (BH) radio link control (RLC) channel (CH) identifier (ID), a BH RLC CH QoS, an evolved-UMTS terrestrial radio access network (E-UTRAN) BH RLC CH QoS, a control plane traffic type, a data radio bearer (DRB) ID, a QoS of a DRB, a F1 user plane interface (F1-U) GPRS tunneling protocol (GTP) tunnel ID, or a QoS of a F1-U tunnel.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
sending, by a first integrated access and backhaul (IAB) donor, an Xn application protocol (XnAP) message to transfer an updated information of an JAB node to a second IAB donor.

2. The method of claim 1, comprising:
receiving, by the first IAB donor prior to sending the XnAP message, a message from an IAB entity.

3. The method of claim 2, wherein at least one of:
the first IAB donor comprises a F1-terminating donor, or a source IAB donor, or an initial IAB donor;
the IAB entity comprises an IAB node or the second IAB donor; or
the message includes an indication to the first IAB donor to maintain at least one of: a user equipment (UE) context, a mobile termination (MT) context or a UE-associated Xn connection between the first IAB donor and the second IAB donor.

4. The method of claim 2, comprising:
sending, by the first IAB donor, a request to the second IAB donor, to indicate that at least one of: a user equipment (UE) context, a mobile termination (MT) context or an UE-associated Xn connection between the first IAB donor and the second IAB donor, is to be maintained.

5. The method of claim 2, wherein the XnAP message comprises a UE-associated XnAP message.

6. The method of claim 2, wherein at least one of:
the first IAB donor comprises a F1-terminating donor, or a source IAB donor, or an initial IAB donor;
the IAB entity comprises an IAB node or a second IAB donor; or
the message includes an identifier of the IAB node, the identifier including at least one of: a distributed unit (DU) identifier (ID), a backhaul adaptation protocol (BAP) address of the IAB node that is allocated by the non F1-terminating donor, an internet protocol (IP) address of the IAB node that is allocated by the non F1-terminating donor, or a UE F1 application protocol (F1AP) ID of an IAB mobile termination (IAB-MT).

7. The method of claim 1, comprising:
sending, by the first IAB donor to the second IAB donor, a non-UE-associated XnAP message to transfer an updated information of an IAB node to the second IAB donor, the non-UE-associated XnAP message including an identifier of the IAB node.

8. The method of claim 1, wherein at least one of:
the updated information includes at least one of: an IAB node configuration information, or quality of service (QoS) information;
the IAB node configuration information includes at least one of: multiplexing capability information, an activated cell list, a DUF configuration, a hard/soft/not-available (HSNA) configuration, a cell specific signal or channel configuration; or
the QoS information includes at least one of: a backhaul (BH) radio link control (RLC) channel (CH) identifier (ID), a BH RLC CH QoS, an evolved-UMTS terrestrial radio access network (E-UTRAN) BH RLC CH QoS, a control plane traffic type, a data radio bearer (DRB) ID, a QoS of a DRB, a F1 user plane interface (F1-U) GPRS tunneling protocol (GTP) tunnel ID, or a QoS of a F1-U tunnel.

9. A method, comprising:
receiving, by a second integrated access and backhaul (IAB) donor from a first IAB donor, an Xn application protocol (XnAP) message to transfer an updated information of an IAB node to the second IAB donor.

10. A second integrated access and backhaul (IAB) donor, comprising:
at least one processor configured to:
receive, via a receiver from a first IAB donor, an Xn application protocol (XnAP) message to transfer an updated information of an IAB node to the second IAB donor.

11. A first integrated access and backhaul (IAB) donor, comprising:
at least one processor configured to:
send, via a transmitter, an Xn application protocol (XnAP) message to transfer an updated information of an IAB node to a second IAB donor.

12. The first IAB donor of claim 11, comprising:
receiving, by the first IAB donor prior to sending the XnAP message, a message from an IAB entity.

13. The first IAB donor of claim 12, wherein at least one of:
the first IAB donor comprises a F1-terminating donor, or a source IAB donor, or an initial IAB donor;
the IAB entity comprises an IAB node or the second IAB donor; or
the message includes an indication to the first IAB donor to maintain at least one of: a user equipment (UE) context, a mobile termination (MT) context or a UE-associated Xn connection between the first IAB donor and the second IAB donor.

14. The first IAB donor of claim 12, comprising:
sending, by the first IAB donor, a request to the second IAB donor, to indicate that at least one of: a user equipment (UE) context, a mobile termination (MT) context or an UE-associated Xn connection between the first IAB donor and the second IAB donor, is to be maintained.

15. The first IAB donor of claim 12, wherein the XnAP message comprises a UE-associated XnAP message.

16. The first IAB donor of claim 12, wherein at least one of:
the first IAB donor comprises a F1-terminating donor, or a source IAB donor, or an initial IAB donor;
the IAB entity comprises an IAB node or a second IAB donor; or
the message includes an identifier of the IAB node, the identifier including at least one of: a distributed unit (DU) identifier (ID), a backhaul adaptation protocol (BAP) address of the IAB node that is allocated by the non F1-terminating donor, an internet protocol (IP) address of the IAB node that is allocated by the non F1-terminating donor, or a UE F1 application protocol (F1AP) ID of an IAB mobile termination (IAB-MT).

17. The first IAB donor of claim 11, comprising:
sending, by the first IAB donor to the second IAB donor, a non-UE-associated XnAP message to transfer an updated information of an IAB node to the second IAB donor, the non-UE-associated XnAP message including an identifier of the IAB node.

18. The first IAB donor of claim 11, wherein at least one of:
the updated information includes at least one of: an IAB node configuration information, or quality of service (QoS) information;
the IAB node configuration information includes at least one of: multiplexing capability information, an activated cell list, a DUF configuration, a hard/soft/not-available (HSNA) configuration, a cell specific signal or channel configuration; or
the QoS information includes at least one of: a backhaul (BH) radio link control (RLC) channel (CH) identifier (ID), a BH RLC CH QoS, an evolved-UMTS terrestrial radio access network (E-UTRAN) BH RLC CH QoS, a control plane traffic type, a data radio bearer (DRB) ID, a QoS of a DRB, a F1 user plane interface (F1-U) GPRS tunneling protocol (GTP) tunnel ID, or a QoS of a F1-U tunnel.

19. A non-transitory computer readable storage medium storing instructions, which when executed by one or more processors can cause the one or more processors to perform the method of claim 1.

20. A non-transitory computer readable storage medium storing instructions, which when executed by one or more processors can cause the one or more processors to perform the method of claim 9.
